(19) United States
(12) Patent Application Publication
(10) Pub. No.: US 2014/0064896 A1
(43) Pub. Date: Mar. 6, 2014

(54) Sto and Go Ramps

(71) Applicant: Vijay Parmar, Langenburg (CA)

(72) Inventor: Vijay Parmar, Langenburg (CA)

(21) Appl. No.: 14/012,360

(22) Filed: Aug. 28, 2013

Related U.S. Application Data
(60) Provisional application No. 61/696,866, filed on Sep. 5, 2012.

(51) Int. Cl. B60P 1/43

(52) U.S. Cl. CPC B60P 1/435
USPC 414/537

(57) ABSTRACT

A ramp system is disclosed that enables users to load and unload objects into the back of a vehicle. The ramp system comprises a ramp, and a housing unit secured within the back of the vehicle for storing the ramp. The ramp is removable from the housing unit and secured to a tailgate of the vehicle. The ramps would generally be configured in a ladder-like configuration comprising vertical support bars and a plurality of rungs. Typically, the ramps are secured to the tailgate of the vehicle via a bungee cord, hook, or hook ends. The housing unit is typically C-shaped and positioned on an inside of a vehicle walls, above a wheel well. The housing unit comprises a clamp and a lip for securing the ramps during transport, a locking-hinge lid which allows easy access to the interior of the housing unit, and storage compartments for storing accessories.

### CROSS-REFERENCE

This application claims priority from Provisional Patent Application Ser. No. 61/696,866 filed Sep. 5, 2012.

### BACKGROUND

Traditional ramps are difficult to haul around and take up a lot of space when stored in a truck bed or other vehicle. Instead, many users may store these ramps in their garage when not in use, which can also take up a lot of space. Storing the ramps in a place other than the back of your pickup truck also creates the problem of not having the ramps handy when needed, and can create unnecessary hardship or waste of time. If users do try to store a ramp in the back of their truck or other vehicle, they have to tie and secure the ramp down to prevent it from shifting around and/or damaging the truck or other vehicle in which it is being hauled, which can be both time consuming and highly inconvenient. Similarly, when in use, users also have to secure the ramp to the tailgate with tie straps or other securing means. Because this can be a hassle, some users may not even use tie-down straps or other securing means, which causes a safety concern of the ramps possibly slipping during the loading process. An effective solution is necessary.

The present invention is a combination of easy-to-use pickup truck (or other vehicle) loading ramps and two unique, side-wall housing units that secure the ramps to the inside of the truck bed (or other vehicle) when not in use. The ramp system incorporates a smartly designed bungee cord and hook-fastening system that eliminates the need for additional tie-down straps. This makes the ramp system not only more convenient than other ramps on the market, but it makes them safer as well. This system is ideal for anyone with recreational vehicles, such as ATVs, motorcycles, snowmobiles, and golf carts, as well as anyone who may need access to a ramp wherever they go. Further, the side-wall housing units also incorporate storage drawers/chests in which tools or other accessories can be stored for convenient or emergency use.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

The subject matter disclosed and claimed herein, in one aspect thereof, comprises a ramp system that enables users to load and unload objects into the back of a vehicle, such as a pickup truck or other suitable vehicle. The ramp system comprises at least one ramp, and at least one housing unit secured within the back of the vehicle for storing the at least one ramp. The at least one ramp is removable from the at least one housing unit and secured to a tailgate or other attachment point on a vehicle. The ramps would generally be configured in a rectangular, ladder-like configuration comprising a pair of vertical support bars and a plurality of rungs. Typically, the ramps are secured to the tailgate of the vehicle, when the tailgate is in an open position. The ramps are secured to the tailgate via a bungee cord and hook, or hook ends and a tailgate bar, or any other suitable securing means as is known in the art.

In a preferred embodiment, the ramp system further comprises at least one housing unit for storing the ramps. The housing unit is typically C-shaped and generally rounded off so as not to have sharp edges. Generally, the housing unit is positioned on the inboard side of a vehicle walls, above a wheel well. Furthermore, the housing unit can comprise a clamp for securing the plurality of rungs of the ramps during transport, and a lip for retaining the ramp within the housing unit during transport. Additionally, the interior of the housing unit can be lined with rubber to prevent damage and noise when transporting the ramps. The housing unit can further comprise a locking-hinge lid which allows easy access to the interior of the housing unit and allows a user to remove and insert the ramps easily and quickly. The housing units also incorporate slide-out drawers and flip-down “glove box” compartments as part of the seamlessly molded unit. These compartments can be used to store tools, gloves, chains, extra recreational parts or accessories, etc., that the user would like to conveniently store in the back of the truck. Typically, one of each type of storage compartment could be incorporated on each housing unit, but that does not have to be the case if one style is deemed more advantageous by the user.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

FIG. 1 illustrates a perspective view of the ramps contained within the housing units of the ramp system in accordance with the disclosed architecture.

FIG. 2 illustrates a perspective view of the housing units with the lids open in accordance with the disclosed architecture.

FIG. 3 illustrates a perspective view of the ramps secured to the tailgate of the vehicle in accordance with the disclosed architecture.

FIGS. 4 A-C illustrate a perspective view of the various mounting options of the ramps on the tailgate in accordance with the disclosed architecture.

FIGS. 5A-B illustrate a perspective view of the various uses of the ramp system in accordance with the disclosed architecture.

### DESCRIPTION OF PREFERRED EMBODIMENTS

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof.

The present invention is a combination of easy-to-use pickup truck (or other vehicle) loading ramps and two unique, side-wall housing units that secure the ramps to the inside of the truck bed (or other vehicle) when not in use. The ramp system incorporates a smartly designed bungee cord and hook-fastening system that eliminates the need for additional tie-down straps. This makes the ramp system not only more convenient than other ramps on the market, but it makes them safer as well. This system is ideal for anyone with recreational vehicles, such as ATVs, motorcycles, golf carts, and snowmobiles (both ramps can be place closer together), as well as anyone who may need access to a ramp wherever they go.

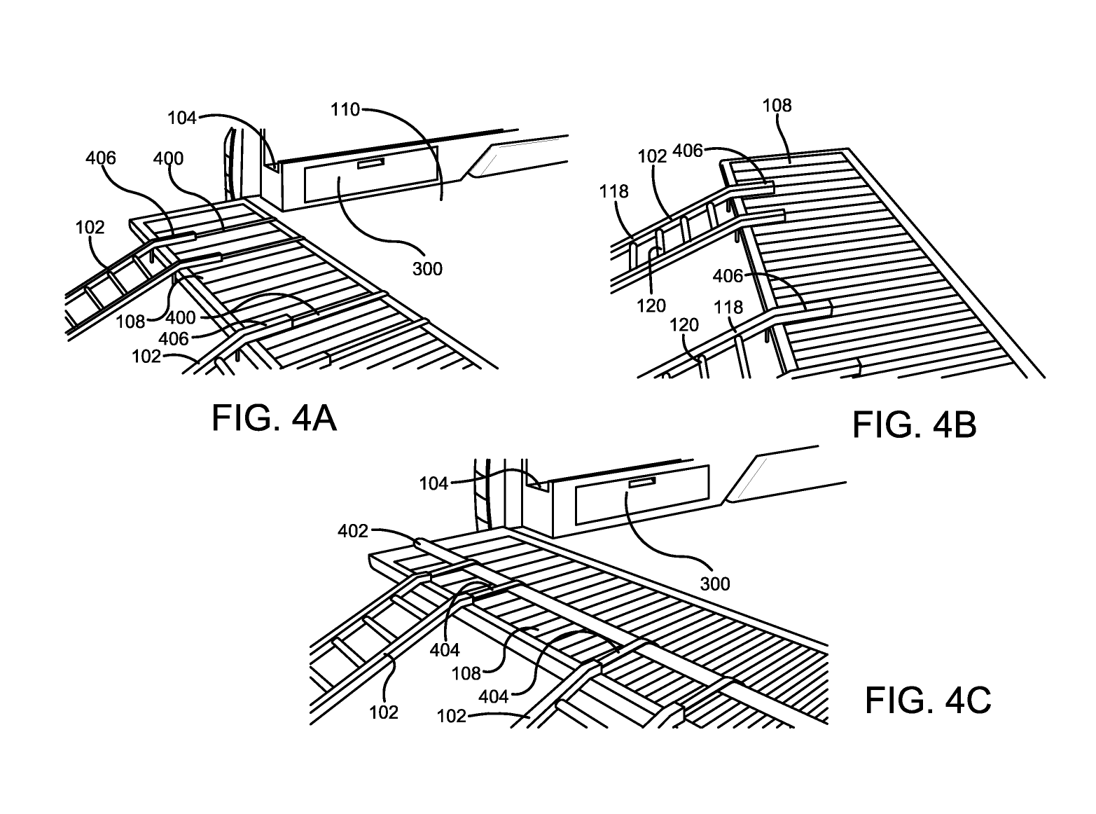

The disclosed ramp system comprises at least one ramp, and at least one housing unit secured within the back of the vehicle for storing the ramp. The ramp is removable from the housing unit and secured to a tailgate of the vehicle. The ramps would generally be configured in a ladder-like configuration comprising a pair of vertical support bars and a plurality of rungs. Typically, the ramps are secured to the tailgate of the vehicle via a bungee cord, hook, or hook ends, and vertical tailgate stops as shown in FIGS. 4A and 4B (the vertical rods that press against the tailgate to prevent it from pulling forward when the bungee cords are attached.) The housing unit is typically C-shaped and positioned on an inboard side of a vehicle walls, above a wheel well. The housing unit comprises a clamp and a lip for removably securing the ramps during transport, and a locking-hinge lid which allows easy access to the interior of the housing unit.

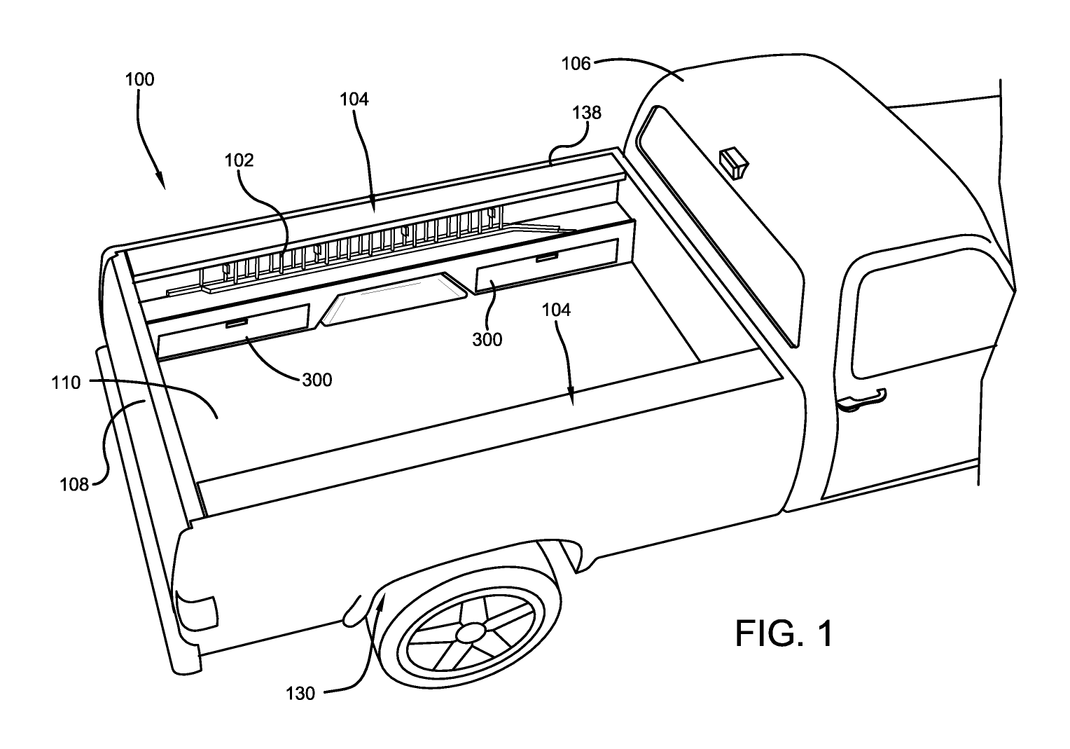

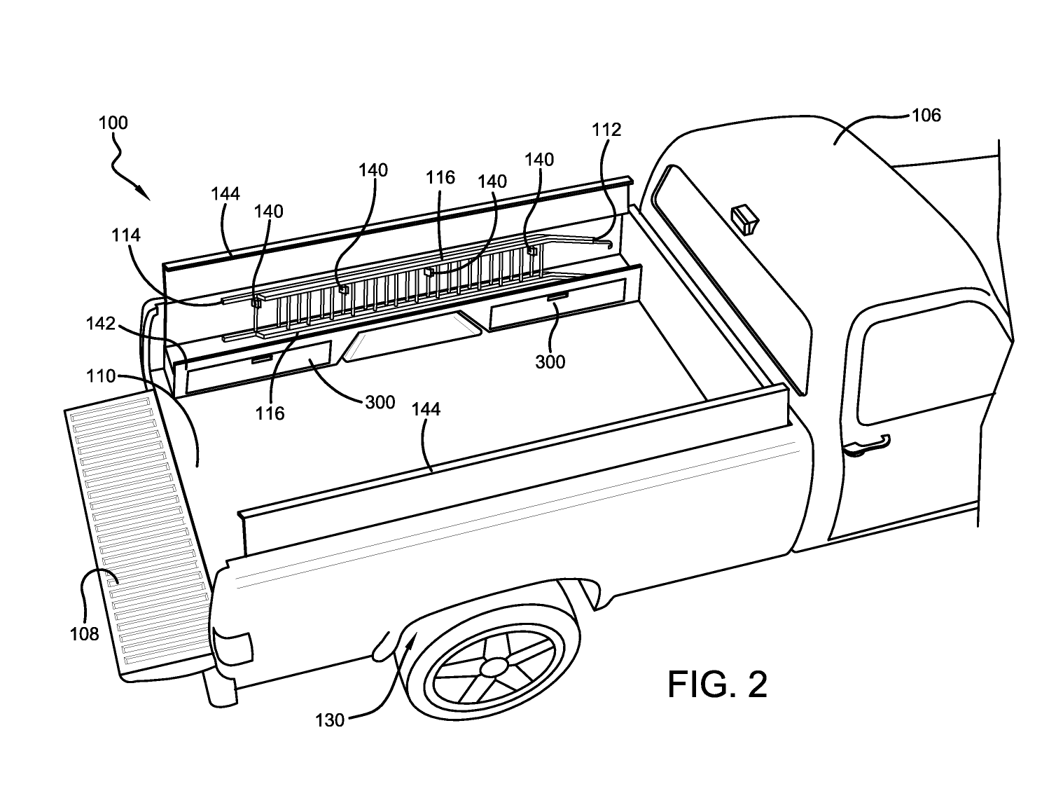

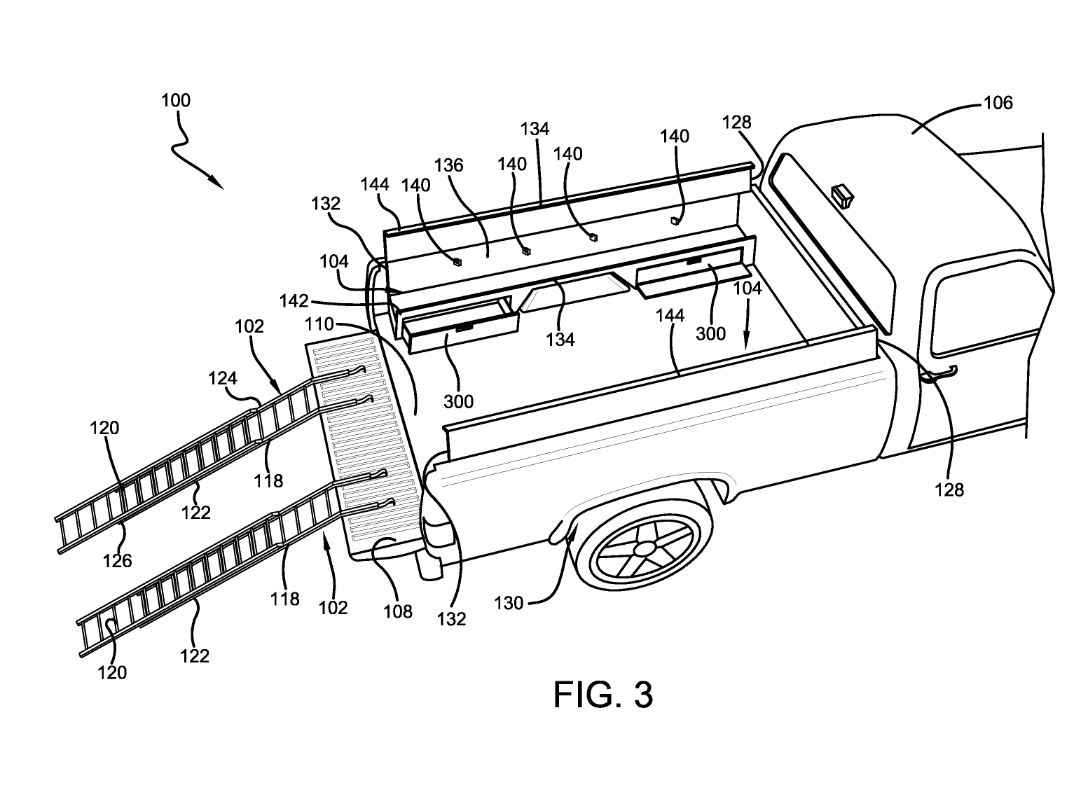

Referring initially to the drawings, FIGS. 1-3 illustrate the ramp system 100 that enables users to load and unload objects into the back 110 of a vehicle 106, such as a pickup truck or other suitable vehicle. The ramp system 100 comprises at least one ramp 102, and at least one housing unit 104 secured within the back 110 of the vehicle 106 for storing the at least one ramp 102. The at least one ramp 102 is removable from the at least one housing unit 104 and may be secured to a tailgate 108 of the vehicle 106 (as shown in FIG. 3) to function as a ramp.

The ramps 102 comprise a first end 112, a second end 114, and opposing sides 116. Typically, the ramps 102 can be any suitable shape as is known in the art without affecting the overall concept of the invention, such as rectangular, etc. (as shown in FIG. 3). The ramps 102 would generally be configured in a rectangular, ladder-like configuration comprising a pair of vertical support bars 118 and a plurality of rungs 120. However, any suitable shape and configuration can be used as is known in the art.

The ramps 102 would typically be constructed of metal, such as steel, aluminum, etc., though any other suitable material may be used to manufacture the ramps 102 as is known in the art without affecting the overall concept of the invention. Further, the ramps 102 can be adjustable in length via a sliding track 122. A user would pull the ramp 102 along the sliding track 122 (telescoping the ramp 102), extending it out lengthwise and then would secure it in place via a set screw or other securing device. A user can then release the set screw and retract the ramp 102 back into its original position for storage within the housing unit 104.

While the shape and size of the ramps 102 may vary greatly depending on the amount and size of the objects being loaded into the back 110 of a vehicle 106, the ramps 102 are approximately between 48 (when retracted) and 120 (when extended) inches long as measured from the first end 112 to the second end 114, and approximately between 6 and 12 inches wide as measured from opposing sides 116, and approximately between 3 and 9 inches thick as measured from a front surface 124 to a back surface 126.

Typically, the ramps 102 are secured to the tailgate 108 of the vehicle 106, when the tailgate 108 is in an open position. However, the ramps 102 can be secured to any suitable position on the vehicle 106 as is known in the art, as long as the ramps 102 are easily accessible and can function to load and unload an object from the back 110 of a vehicle 106. The ramps 102 are secured to the tailgate 108 via a bungee cord 400 and hook, or hook ends 404 and a tailgate bar 402, or any other suitable securing means as is known in the art to prevent or reduce the likelihood that the ramps will detach from the vehicle during the loading/unloading process.

If a bungee cord and a hook are used, the ramps 102 would have a flat end 406 on either the first 112 or second 114 ends. The flat end 406 would be attached to the tailgate 108 and a bungee cord 400 (as shown in FIG. 4A) would be secured to the flat end 406 and a hook on the end of the bungee cord 400 would be secured to the hinged end of the tailgate 108, securing the ramps 102 to the tailgate 108 for use.

If hook ends 404 are used, the ramps 102 are modified to include a tailgate bar 402 with space around the bar 402 to allow the hook ends 404 to attach (as shown in FIG. 4C). The first 112 or second 114 end of the ramps 102 would be attached to the tailgate 108 and hook ends 404 would be secured to the first 112 or second 114 ends and then secured to the tailgate bar 402, securing the ramps 102 to the tailgate 108 for use.

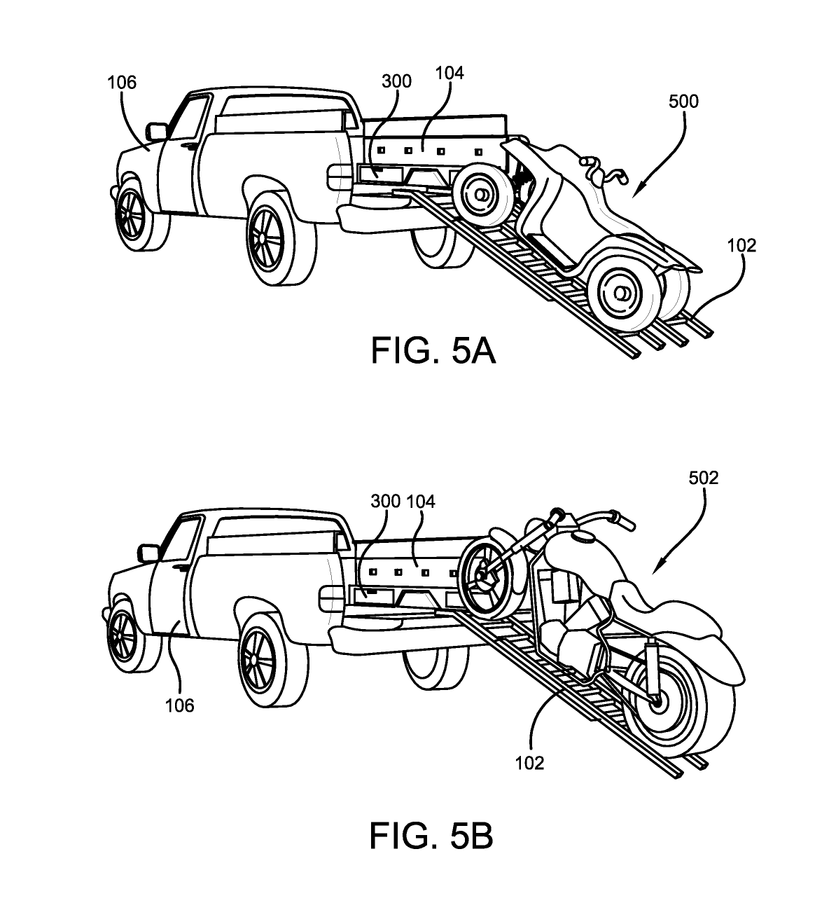

Finally, the ramps 102 can be secured directly to the tailgate 108 via hooks or other securing devices which are attached to the first end 112 of the ramps and then secured directly to the tailgate 108, securing the ramps 102 to the tailgate 108 for use (as shown in FIG. 4B). Users can use two ramps 102 for four-wheeled vehicles/snowmobiles and one ramp 102 for two-wheeled vehicles (as shown in FIGS. 5A-B).

The ramp system 100 further comprises at least one housing unit 104 for storing the ramps 102. The housing unit 104 comprises a first end 124, a second end 126, and opposing sides 128. Typically, the housing unit 104 can be any suitable shape as is known in the art without affecting the overall concept of the invention, but typically, the housing unit 104 is C-shaped and generally rounded off so as not to have sharp edges (as shown in FIG. 1). The housing unit 104 could be molded out of a plastic-like material to seamlessly fit into the back of the truck, overtop of the wheel-well and inside the truck body, which would reduce sharp edges.

The housing unit 104 would typically be constructed of metal, such as steel, aluminum, etc., or heavy-duty plastic, such as poly carbonate (PC) or acrylonitrile butadiene styrene (ABS), though any other suitable material may be used to manufacture the housing unit 104 as is known in the art without affecting the overall concept of the invention. Generally, the housing unit 104 is positioned on an inboard side of a vehicle 106 walls, above a wheel well 130, but can be positioned on any suitable position within the back 110 of the vehicle 106 as is known in the art. The housing unit 104 can be secured to the vehicle 106 via any suitable securing means as is known in the art, such as welding, gluing, fasteners, etc. Further, the housing unit 104 does not have to be secured to the vehicle 106 and can function without being secured to the vehicle 106.

While the shape and size of the housing units 104 may vary greatly depending on the amount and size of the ramps 102 being stored in them and depending on the shape and size of the vehicle 106 retaining them, the housing units 104 are approximately between 48 and 96 inches long as measured from the first end 128 to the second end 132, and approximately between 6 and 12 inches wide as measured from opposing sides 134, and approximately between 4 and 10 inches thick as measured from a front surface 136 to a back surface 138.

Furthermore, the housing unit 104 comprises at least one clamp 140 or any other suitable securing device within the interior, to secure the plurality of rungs 120 of the ramps 102 during transport. However, the housing unit 104 does not need the clamp 140 and can function without it. The housing unit 104 can further comprise a lip 142 to retain the ramps 102 within the housing unit 104 during transport. The lip 142 allows the ramps 102 to remain within the housing unit 104 while the vehicle 106 is moving.

The housing units 104 also incorporates storage compartments 300, such as slide-out drawers and flip-down “glove box” compartments as part of the seamlessly molded unit. These storage compartments 300 can be used to store tools, gloves, chains, extra recreational parts or accessories, etc., that the user would like to conveniently store in the back of the truck (vehicle 106). Typically, one of each type of storage compartment 300 could be incorporated on each housing unit 104, but that does not have to be the case if one style is deemed more advantageous by the user.

Additionally, the interior of the housing unit 104 can be lined with rubber or any other suitable material to prevent damage and noise when transporting the ramps 102. The housing unit 104 can further comprise a locking-hinge lid 144, or any other suitable covering for the housing unit 104. The lid 144 allows easy access to the interior of the housing unit 104 and allows a user to remove and insert the ramps 102 easily and quickly. The locking-hinge allows a user to open the lid 144 and keep it in a raised position for easy access to the interior of the housing unit 104. Typically, there are two housing units 104 for storing two ramps 102, with one ramp 102 being inserted into each housing unit 104.

FIGS. 4A-C illustrate the various mounting options of the ramps 102 on the tailgate 108. As stated supra, the ramps 102 are removably secured to the tailgate 108 of the vehicle 106, when the tailgate 108 is in an open position. However, the ramps 102 can be secured to any suitable position on the vehicle 106 as is known in the art, as long as the ramps 102 can function to load and unload an object from the back 110 of a vehicle 106. The ramps 102 are secured to the tailgate 108 via a bungee cord 400 and hook, or hook ends 404 and a tailgate bar 402, or any other suitable securing means as is known in the art.

If a bungee cord and a hook are used, the ramps 102 would have a flat end 406 on the first end 112. The flat end 406 would be attached to the tailgate 108 and a bungee cord 400 (as shown in FIG. 4A) would be secured to the flat end 406 and a hook on the end of the bungee cord 400 would be secured to the hinged end of the tailgate 108, securing the ramps 102 to the tailgate 108 for use.

If hook ends 404 are used, the ramps 102 are modified to include a tailgate bar 402 with space around the bar 402 to allow the hook ends 404 to attach (as shown in FIG. 4C). The first end 112 of the ramps 102 would be attached to the tailgate 108 and hook ends 404 would be secured to the first ends 112 and then secured to the tailgate bar 402, securing the ramps 102 to the tailgate 108 for use.

Finally, the ramps 102 can be secured directly to the tailgate 108 via hooks or other securing devices which are attached to the first end 112 of the ramps and then secured directly to the tailgate 108, securing the ramps 102 to the tailgate 108 for use (as shown in FIG. 4B).

Furthermore, if the user has removed the tailgate 108, then flip-up and down hooks/clips or a rod could be attached to the vehicle 106 bed floor, to which bungee hooks 404 could be attached. The flip-up and down hooks/clips or bar would be unassuming in nature, so as to not create an unnecessary obstacle in the truck bed.

FIGS. 5 A-B illustrate various uses of the ramp system 100. For example, the ramp system 100 can be configured to be used with four-wheeled vehicles 500 (as shown in FIG. 5A), or can be configured to be used with two-wheeled vehicles 502 (as shown in FIG. 5B). When used with four-wheeled vehicles 500, or snowmobiles, two ramps 102 are utilized and a user (not shown) removably secures both ramps 102 to the tailgate 108 of the vehicle 106 via any of the securing means disclosed in FIGS. 4A-C. When used with two-wheeled vehicles 502, one ramp 102 is used and a user secures the ramp 102 to the tailgate 108 of the vehicle 106 via any of the securing means disclosed in FIGS. 4A-C. Once secure, the ramps 102 are then used as prior art ramps to load and unload objects into the back 110 of the vehicle 106. After use, the ramps 102 can then be stored in the housing units 104 positioned on an inboard side of a vehicle 106 walls, above a wheel well 130, with one ramp 102 being stored in each housing unit 104.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A ramp system for enabling users to load and unload objects into a back of a vehicle comprising:
at least one ramp comprising a first end and a second end and a pair of opposing sides; and
at least one housing unit secured within the back of the vehicle for storing the at least one ramp; and
wherein the at least one ramp is removable from the at least one housing unit and secured to a tailgate of the vehicle.

2. The ramp system of claim 1, wherein the at least one ramp comprises a flat end on either the first or the second ends, and the flat end is secured to the tailgate via a bungee cord and a hook.

3. The ramp system of claim 1, wherein the at least one ramp comprises hook ends on either the first or the second ends, and the hook ends are secured to a tailgate bar on the tailgate.

4. The ramp system of claim 1, wherein the at least one ramp is adjustable in length via a sliding track.

5. The ramp system of claim 4, wherein the at least one ramp is configured in a ladder-like configuration comprising a pair of vertical support bars and a plurality of rungs.

6. The ramp system of claim 5, wherein the at least one housing unit further comprises at least one clamp to secure the plurality of rungs of the at least one ramp during transport.

7. The ramp system of claim 1, wherein the at least one housing unit is C-shaped and positioned on an inside of a vehicle walls, above a wheel well.

8. The ramp system of claim 1, wherein the at least one housing unit further comprises a lip to retain the at least one ramp.

9. The ramp system of claim 1, wherein the at least one housing unit further comprises a locking-hinge lid.

10. The ramp system of claim 1, wherein the at least one housing unit is lined with rubber to prevent damage and noise when transporting the at least one ramp.

11. The ramp system of claim 1, wherein there are two ramps and two housing units for storing the two ramps, one ramp in each housing unit.

12. A ramp system for enabling users to load and unload objects into a back of a vehicle comprising:
at least one ramp comprising a first end and a second end and configured in a ladder-like configuration comprising a pair of vertical support bars and a plurality of rungs; and
at least one housing unit secured within the back of the vehicle for storing the at least one ramp; and
wherein the at least one ramp is removable from the at least one housing unit and secured to a tailgate of the vehicle via a bungee cord and a hook; and
wherein the at least one ramp is adjustable in length via a sliding track.

13. The ramp system of claim 12, wherein the at least one housing unit further comprises at least one clamp to secure the plurality of rungs of the at least one ramp during transport.

14. The ramp system of claim 12, wherein the at least one housing unit is C-shaped and positioned on an inside of a vehicle walls, above a wheel well.

15. The ramp system of claim 12, wherein the at least one housing unit further comprises a lip to retain the at least one ramp.

16. The ramp system of claim 12, wherein the at least one housing unit further comprises a locking-hinge lid.

17. The ramp system of claim 12, wherein the at least one housing unit is lined with rubber to prevent damage and noise when transporting the at least one ramp.

18. The ramp system of claim 12, wherein there are two ramps and two housing units for storing the two ramps, one ramp in each housing unit.

19. A ramp system for enabling users to load and unload objects into a back of a vehicle comprising:
a pair of ramps comprising a first end and a second end and configured in a ladder-like configuration comprising a pair of vertical support bars and a plurality of rungs; and
a pair of housing units secured within the back of the vehicle for storing the pair of ramps, with one ramp stored in each housing unit; and
wherein the pair of ramps are removable from the pair of housing units and secured to a tailgate of the vehicle via hook ends which are secured to a tailgate bar on the tailgate of the vehicle.

20. The ramp system of claim 19, wherein the pair of housing units each comprise at least one storage compartment.
